(19) United States
(12) Patent Application Publication
(10) Pub. No.: US 2021/0126387 A1
(43) Pub. Date: Apr. 29, 2021

(54) SOLDERING CONTACT AND CONTACT MODULE, AND METHOD FOR PRODUCING A CONTACT MODULE

(71) Applicant: PHOENIX CONTACT GMBH & CO. KG, Blomberg (DE)

(72) Inventors: Andreas SCHRADER, Delbrueck (DE); Klaus-Michael BATH, Blomberg (DE)

(21) Appl. No.: 16/756,991

(22) PCT Filed: Oct. 11, 2018
(86) PCT No.: PCT/EP2018/077741

§ 371 Date: Apr. 17, 2020

(30) Foreign Application Priority Data
Oct. 20, 2017 (DE) 10 2017 124 549.9

(51) Int. Cl. H01R 12/57; H01R 43/02; H01R 43/16; H01R 12/58

(52) U.S. Cl. CPC H01R 12/57; H01R 43/0256; H01R 12/58; H01R 43/16; H01R 43/0235

(57) ABSTRACT

A solder contact, having a contact region for the contact-connection of a plug contact, having at least one SMD solder surface, which is configured for soldering to a printed circuit board and for materially bonded connection to a solder pin and having at least one recess, which is configured to receive a solder pin.

### FIELD

The invention relates to a soldering contact, to a contact module for a printed circuit board, and to a method for producing a contact module for a printed circuit board.

### BACKGROUND

Known contact modules configured for soldering to a printed circuit board have one to soldering contact per pole, which effects contacting to a plug connector that can be connected to the contact module. Such a soldering contact, which is usually metallic, has a soldering region that is soldered to the printed circuit board. This region may be realized as an SMD soldering surface, where SMD stands for “surface-mount device”, as a single soldering pin, or as an arrangement of a plurality of soldering pins formed integrally with the soldering contact.

In the production of such a contact module such as, for example, a contact socket or a base strip for a printed circuit board, soldering contacts having either an SMD soldering surface, having a single soldering pin or having a plurality of soldering pins are fitted, depending on the specific connection. Accordingly, in the production of contact sockets or base strips, a separate variant of soldering contacts to be fitted must be available for each variant of the intended connection to the printed circuit board.

Furthermore, a separate design of soldering contacts is required for each orientation of such a contact module on a printed circuit board, for example if an insertion direction of a plug connector is to have an orientation parallel or perpendicular relative to a plane of the printed circuit board. If a contact socket is to have, for example, an opening, for receiving a plug connector, that has an orientation perpendicular to a plane of the printed circuit board, corresponding soldering contacts are fitted, which also have soldering pins oriented perpendicularly in relation to the printed circuit board. In the case of an insertion direction having an orientation parallel to a PCB plane, the soldering contacts are oriented transversely relative to the insertion direction.

Usually, separate variants of the soldering contacts to be fitted are kept in stock for all of these connection and orientation variants. The associated variant diversity of the individual components to be provided for the production of contact modules results in high costs.

### SUMMARY

Against this background, the present invention is based on the technical object of specifying a soldering contact, a contact module for a printed circuit board, and a method of producing a contact module, that do not have the disadvantages described above, or that at least have them to a lesser extent, and in particular to specify a soldering contact that is flexible with respect to the type of connection and orientation to be provided, and that thus enables a plurality of connection variants to be provided in a cost-effective manner.

According to a first aspect, the invention relates to a soldering contact, having a contact region for contacting a plug connector contact, having at least one SMD soldering surface, which is configured for soldering to a printed circuit board and for materially bonded connection to a soldering pin, and having at least one recess, which is configured to receive a soldering pin.

Since the soldering contact according to the invention has an SMD soldering surface that, in itself, is suitable for connection to a printed circuit board, and the soldering contact is also configured for the materially bonded fastening of soldering pins, the soldering contact can be used both for contact modules that are to be connected by means of SMD technology and for those which are intended for connection by means of soldering pins, in that the soldering contact can optionally be equipped with soldering pins.

In this way, the number of variants of the soldering contacts to be provided for the realization of differing contact modules can be reduced considerably. The soldering contact according to the invention therefore enables cost savings in the production of contact modules for printed circuit boards.

The proposed soldering contact can thus be used without a soldering pin, as an SMD soldering contact. In such a case, there is no soldering pin, either fastened to an SMD soldering surface or received within the recess provided for receiving a soldering pin.

According to a development of the invention, it is provided that at least one soldering pin is provided, which is connected in a materially bonded manner to the SMD soldering surface. The SMD soldering surface can thus be used to fasten a soldering pin that, for example, is welded, soldered and/or adhesive-bonded to the SMD soldering surface.

Alternatively or additionally, it may be provided that at least one soldering pin is received, at least portionally, in the recess, and is connected in a materially bonded manner to a surface that delimits the recess and/or adjoins the recess. It is thus possible, for example, to specify a soldering contact that has an SMD soldering surface not provided with a soldering pin, while a soldering pin is received in the recess and fastened in a materially bonded manner.

Accordingly, the soldering contact suitable for the SMD method can be modified by connecting a soldering pin within the recess, such that the soldering contact is suitable for materially bonded connection to a printed circuit board, via the soldering pin.

Alternatively or additionally, it may be provided that both a soldering pin is received, at least portionally, in the recess and connected in a materially bonded manner, and a further, second, soldering pin is fastened in a materially bonded manner to the SMD soldering surface. Accordingly, the soldering contact has two soldering pins, which can be soldered to an associated printed circuit board.

The soldering contact may therefore be equipped with no soldering pins, or with one, two or more soldering pins.

The soldering contact may have two or more recesses for receiving soldering pins. The recesses may serve both to provide connection variants in respect of the number of soldered connections to a printed circuit board and to enable variants in respect of the orientation of the contact region relative to a printed circuit board.

Alternatively or additionally, two or more SMD soldering surfaces may be provided, which are configured for soldering to a printed circuit board and for materially bonded connection to a soldering pin. As already discussed above with reference to the variant having a plurality of recesses for receiving soldering pins, a plurality of SMD soldering surfaces may accordingly be used, alternatively or additionally, to enable connection variants in respect of the number of soldered connections of the soldering contact to a printed circuit board, as well as in respect of the orientation of the contact region of the soldering contact relative to the printed circuit board.

The soldering contact thus offers a high degree of flexibility in respect of printed circuit board contacting by means of SMD soldering surfaces, as well as in respect of the possible use of soldering pins.

A longitudinal extent of a soldering pin fastened to the SMD soldering surface or seated in the recess may be oriented transversely in relation to, or along, an insertion direction of the plug connector contact.

“Transversely in relation to an insertion direction” means here that a longitudinal extent of the soldering pin may have an angle of, for example, approximately 90° in relation to the insertion direction of a plug connector contact, or a plug connector. In a fully assembled state on a printed circuit board, the insertion direction may have an orientation parallel to a face plane in which the printed circuit board extends, while the longitudinal extent of the soldering pins passes through the face plane of the printed circuit board extent essentially perpendicularly.

According to an alternative variant, according to which the longitudinal extent of the soldering pins is oriented “along an insertion direction” of a plug connector contact, or of a plug connector, both the longitudinal extent of the soldering pin and the insertion direction of a plug connector into the contact region of the soldering contact have an orientation parallel to each other and, in particular, are each oriented substantially perpendicularly in relation to a face plane spanned by the printed circuit board.

The structural design of the contact region of the soldering contacting may be such, for example, that the contact region has at least two projecting webs. According to the examples described above, a longitudinal extent of the soldering pin of the soldering contact may be oriented transversely, or along, a longitudinal extent of the webs.

In particular, the webs in this case may have an orientation substantially parallel to an insertion direction of a plug connector contact, or of a plug connector. If the longitudinal extent of the soldering pin is oriented transversely in relation to an insertion direction and/or a longitudinal extent of webs of the contact region, it may be provided, for example, that the longitudinal extent of the soldering pin in relation to the insertion direction, or longitudinal extent, of a web has an angle in a range of between 0° and 90°. It may thus be provided, for example, that a soldering pin has a longitudinal extent that includes an angle of 45° in relation to a direction of insertion and/or in relation to a longitudinal extent of the web that has an orientation parallel to the insertion direction. Variants of the orientation of the soldering pins may be specified by the orientation of the recess or the orientation of the SMD soldering surface.

It may therefore be provided, according to a development of the soldering contact, that the recess and/or the SMD soldering surface are/is oriented transversely in relation to, or along, an insertion direction of the plug connector contact. Alternatively or additionally, it may be provided that the contact region has at least two projecting webs, wherein the recess and/or the SMD soldering surface are/is oriented transversely in relation to, or along, a longitudinal extent of the webs.

The recess may be a punch-out in the form of a groove, which describes a profile, open toward one side of the soldering contact, into which a soldering pin can be inserted.

It may be provided that projecting webs of the soldering contact delimit a receiver for the insertion of a plug connector contact, with respective recesses for the insertion of soldering pins being provided on the adjoining sides.

In particular, one recess may be provided on each of the side surfaces that adjoin the contact region and on a rear side that faces away from the contact region, i.e. three recesses in total. In the fully assembled state, the recesses enable an insertion direction to have an orientation that is perpendicular, parallel or inclined relative to a printed circuit board plane, depending on the positioning of one or more soldering pins.

According to a development of the soldering contact, it is provided that respectively one soldering pin is fastened in a recess and on an SMD soldering surface, the longitudinal extents of which pins have an orientation substantially parallel to each other. Two materially bonded connections to a printed circuit board can thus be realized by means of the soldering pins. Alternatively, it may be provided that just one single soldering pin is provided, which is fastened in a recess or on an SMD surface.

If the contact region has at least two projecting webs, the webs may have end contact lugs that face toward each other and that form a local constriction of the contact region for receiving the plug connector contact.

The contact lugs may effect a defined contacting of a plug connector contact. The projecting webs may be realized as spring arms, which are configured to bear against an assigned plug connector contact in a resiliently tensioned manner Such a spring arm may be deflected by insertion of a plug connector on a surface of the plug connector in a sliding manner, transversely in relation to the insertion direction of the plug connector, or of the plug connector contact, and thus be resiliently tensioned against a plug connector contact. In this way it is possible to achieve simple, reliable and non-destructively detachable contacting between a plug connector contact and the socket soldering contact.

It may be provided that at least one of the webs has a latching projection for locking a plug connector housing, the latching projection being arranged, in particular, on a side of the web that faces away from a contact lug. A latching projection may be configured to engage in a recess, a projection or an undercut of a plug housing in order to secure a plug connector, in a form-fitting and/or force-fitting manner, against being withdrawn in a direction oriented contrary to the insertion direction, or loss of the plug connector.

According to a second aspect, the invention relates to a contact module for a printed circuit board, comprising a plastic housing, comprising at least one receiving opening for insertion of a plug connector, and comprising at least one soldering contact that is assigned to the receiving opening and accommodated in the plastic housing, wherein the soldering contact is realized in the manner according to the invention.

It may be provided that the contact module has a plurality of soldering contacts, each soldering contact being assigned to a single pole of a plug connector, or of a plug connector contact to be connected.

The contact module may be a contact socket or base strip, which is configured for soldering to a printed circuit board. The contact module may be configured for connection to a printed circuit board by the SMD method. Alternatively, one or more soldering pins, configured to be soldered to a printed circuit board, may be provided on each soldering contact.

It is thus possible to specify a contact module that allows a high number of variants in respect of the possible method of connection to a printed circuit board, the soldering contact or contacts being respectively equipped with one or more soldering pins, depending on requirements.

According to a third aspect, the invention relates to a method for producing a contact module for a printed circuit board, comprising the method steps:
providing a soldering contact according to the invention or a plurality of soldering contacts according to the invention;
inserting the soldering contact or soldering contacts into a plastic housing;
wherein, optionally, materially bonded connecting of at least one soldering pin to the SMD soldering surface is effected, and/or
optionally, materially bonded connecting of at least one soldering pin to a surface that delimits the punch-out and/or that adjoins the punch-out is effected, wherein the soldering pin is received, at least portionally, in the recess.

The method according to the invention makes it possible to produce a large number of contact module variants in a flexible and inexpensive manner, since the soldering contacts can be adapted to the respective variant of the contact module to be produced. In this case, the variant-specific adaptation of the soldering contact makes it possible to produce, for example, an insertion direction for a plug connector contact having an orientation that is perpendicular, parallel or inclined relative to a printed circuit board, in that one or more soldering pins are respectively fastened to the soldering contacts in a recess having an orientation that is perpendicular, parallel or inclined, and/or are fastened to an SMD soldering surface having an orientation that is perpendicular, parallel or inclined. It is thus possible to produce, for example, inclined variants that correspond to an orientation of the insertion direction, with respect to a printed circuit board plane, of approximately 45°. It is thus possible to dispense with the use of soldering pins, such that only the SMD contact surfaces are used to connect the contact module produced in each case to a printed circuit board. The orientations or angles mentioned above relate to a face plane spanned by a printed circuit board when the produced contact module is in the fully assembled state.

Accordingly, a soldering contact, a contact module and a method for producing a contact module are specified, which make it possible to produce a large number of contact module variants at low cost, while at the same time stocks of soldering contact variants are kept low.

### BRIEF DESCRIPTION OF THE DRAWINGS

The invention is explained in greater detail in the following on the basis of a drawing representing exemplary embodiments. These show, schematically in each case:

FIG. 1 a soldering contact according to the invention, in a perspective view from above;

FIG. 2 a further soldering contact according to the invention, in a side view;

FIG. 3 the soldering contact from FIG. 2, in an assembled state;

FIG. 4 a further soldering contact according to the invention, in a side view;

FIG. 5 the soldering contact from FIG. 4, in an assembled state;

FIG. 6 a further soldering contact according to the invention, in a side view;

FIG. 7 a further soldering contact according to the invention, in a side view;

FIG. 8 a further soldering contact according to the invention, in a side view; and

FIG. 9 a further soldering contact according to the invention, in a side view.

### DETAILED DESCRIPTION OF THE DRAWINGS

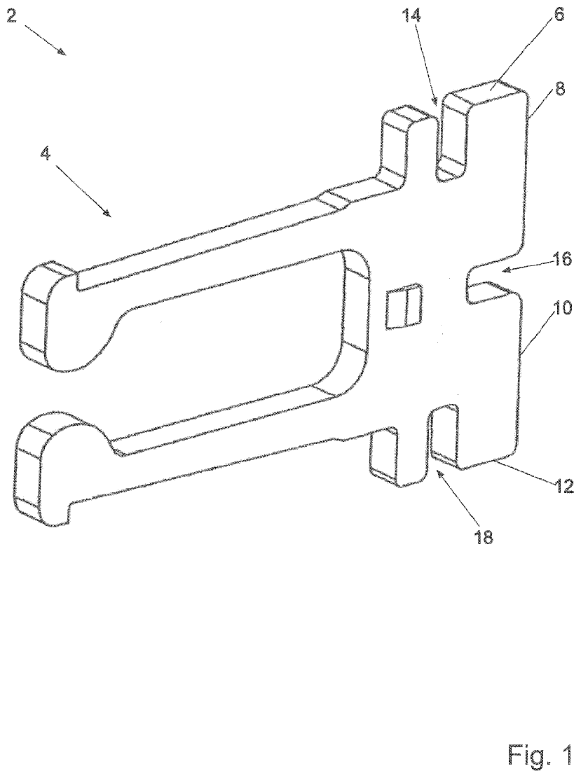

FIG. 1 shows a soldering contact 2 according to the invention. The soldering contact 2 has a contact region 4 for contacting a plug connector contact. The soldering contact 2 has SMD soldering surfaces 6, 8, 10, 12, which are configured for soldering to a printed circuit board and or for materially bonded connection to a soldering pin.

The soldering contact 2 also has recesses 14, 16, 18, which are each configured to receive a soldering pin.

In this case, the soldering contact 2 is composed of an electrically conductive metallic material. The recesses 14, 16, 18 have been produced by punch-outs.

The soldering contact 2 according to FIG. 1 may be used as an SMD soldering contact and fitted, for example, in a contact module such as a contact socket, a base strip or the like. Such a base strip or contact socket, having one or more soldering contacts 2, can in each case be soldered to a printed circuit board by means of the SMD soldering surfaces 6, 8, 10, 12.

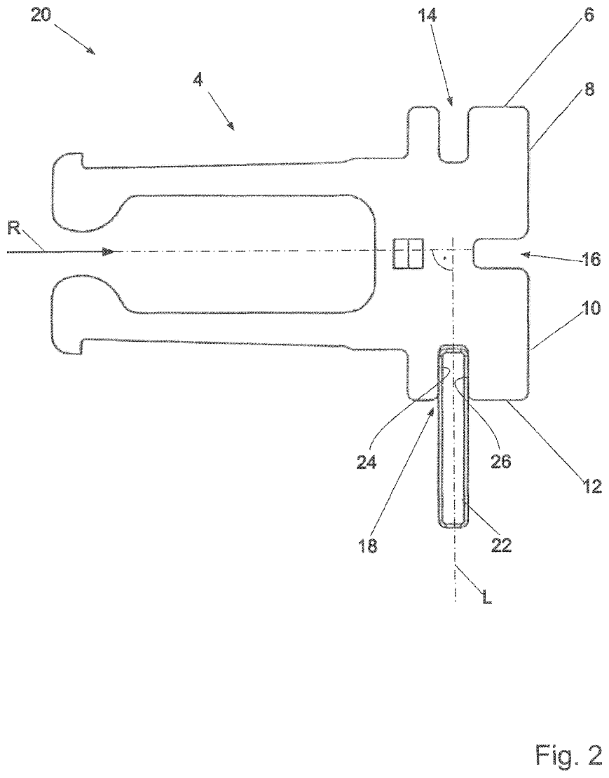

FIG. 2 shows a further development of a soldering contact 20 according to the invention. In order to avoid repetitions, only the differences between the embodiment variants described below and the exemplary embodiment described above are discussed, and features that are the same are denoted by the same references.

The soldering contact 20 according to FIG. 2 has a soldering pin 22, which has been received in the recess 18 and connected in a materially bonded manner to the surfaces 24, 26 delimiting the recess 18.

A longitudinal extent of the soldering pin 22 along its longitudinal extent L is oriented transversely in relation to an insertion direction R of the plug connector contact to be connected. In this case, an angle of 90° is provided between the insertion direction R and the longitudinal axis L.

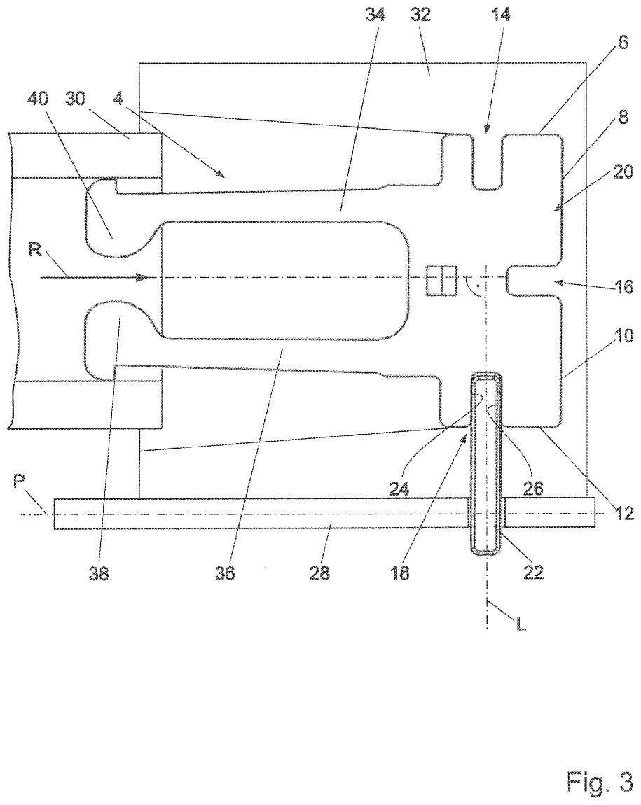

FIG. 3 shows the fully assembled state of the soldering contact 20 relative to a printed circuit board 28. According to this, the insertion direction R has an orientation that is substantially parallel to a face plane P spanned by the printed circuit board 28.

In other words, a plug connector contact 30 is then accordingly pushed onto the contact region 4 of the soldering contact 20, parallel to a face plane spanned by the printed circuit board 28. The soldering contact 20 in this case is accommodated in a plastic housing 32 of a contact module, such as a contact socket or base strip.

The contact region 4 has two projecting webs 34, 36, the longitudinal extent of which has an orientation substantially parallel to the insertion direction R. Accordingly, the longitudinal extent of the soldering pin 22 along the longitudinal axis L is likewise oriented transversely in relation to the longitudinal extent of the webs 34, 36. In this case, the webs 34, 36 form spring arms, each having end contact lugs 38, 40, in the region of which a local constriction is formed.

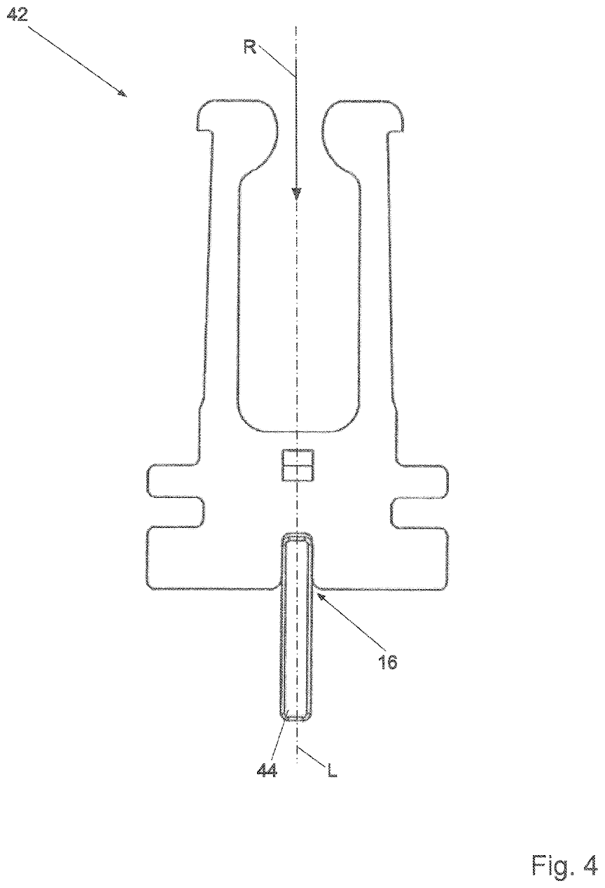

FIG. 4 shows a further variant of a soldering contact 42, which differs from the previously described exemplary embodiment of FIGS. 2 and 3 in that there is now a soldering pin 44 received in the recess 16.

According to this, according to the variant of FIG. 4, a longitudinal extent of the soldering pin 44 along its longitudinal axis L has an orientation parallel to an insertion direction R of a plug connector contact, such that the longitudinal extent of the soldering pin 44 along the longitudinal axis L includes an angle of 0° relative to the insertion direction R.

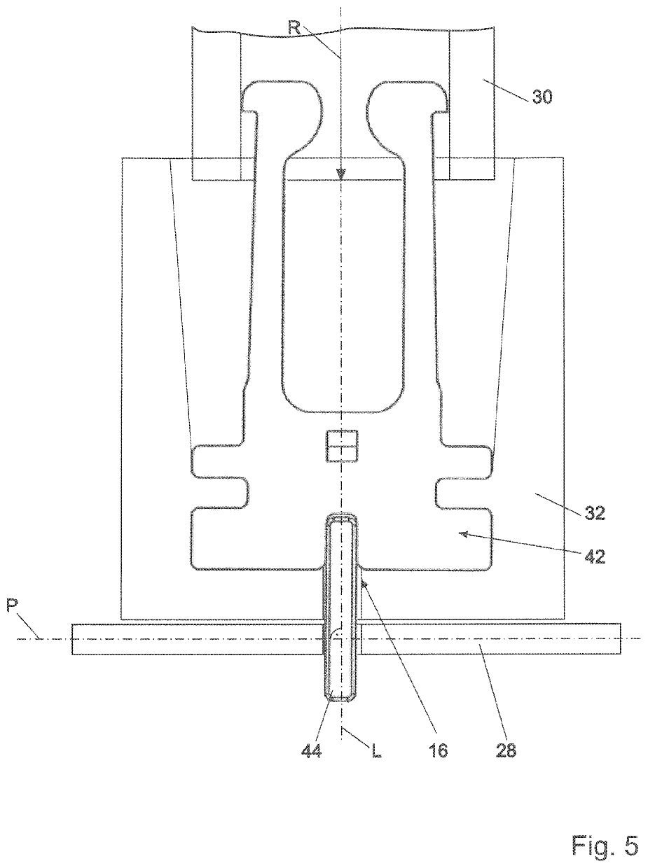

FIG. 5 shows the fully assembled state of such a soldering contact 42, which is accommodated in a plastic housing 32. Owing to the arrangement of the soldering contact 42 in the recess 16, an insertion direction R is now oriented perpendicularly in relation to the face plane P spanned by the printed circuit board 28.

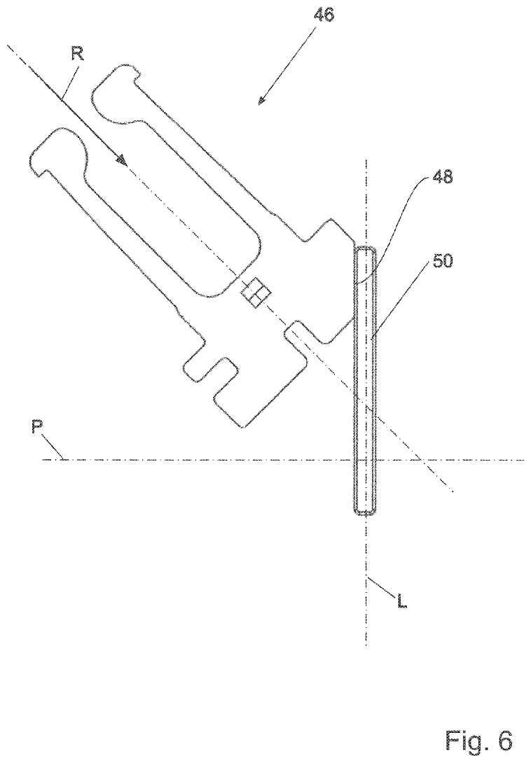

FIG. 6 shows a further variant of a soldering contact 46, which differs from the previously described exemplary embodiment in an SMD soldering surface 48, which is inclined at an angle of 45° relative to the insertion direction.

A soldering pin 50 is welded to the SMD soldering surface 48, which is inclined at the angle of 45°. This accordingly allows an arrangement of a base strip or contact socket that renders possible an insertion direction R of a plug connector contact, relative to a printed circuit board, that is inclined at an angle of 45° relative to a face plane P of a printed circuit board.

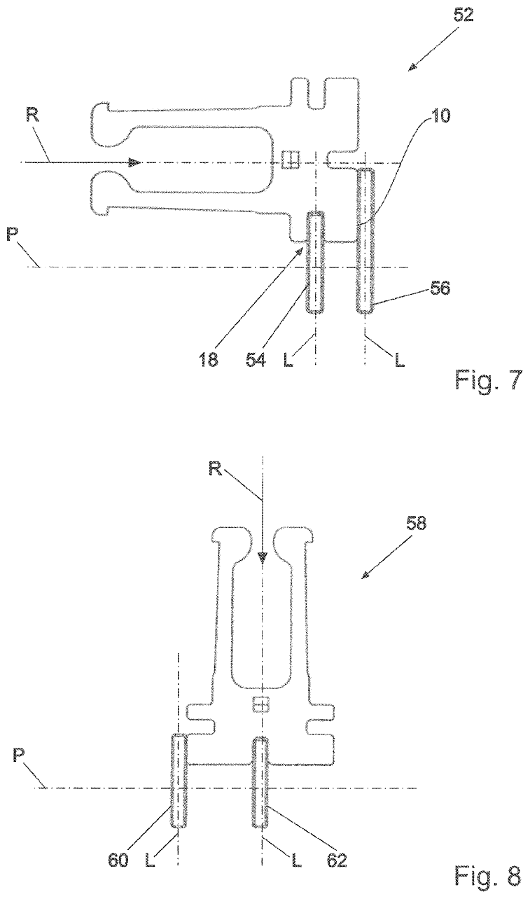

FIG. 7 shows a further variant of a soldering contact 52, which has a soldering pin 54 that is received in the recess 18, and a soldering pin 56 that is welded to the SMD soldering surface 10. Two connections to a printed circuit board can thus be produced for the soldering contact 52.

FIG. 8 shows a soldering contact 58 having an arrangement of two soldering pins 60, 62 that allow an insertion direction R oriented perpendicularly in relation to the face plane P of a printed circuit board.

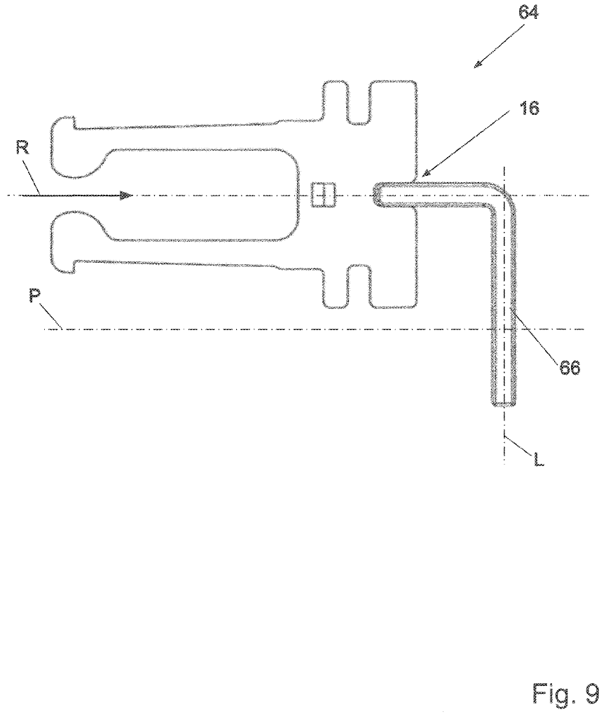

FIG. 9 shows a further variant of a soldering contact 64, having a soldering pin 66 received in the recess 16, the soldering pin 66 in this case being angled by 90° in order to enable an insertion direction R having an orientation parallel to a face plane P of a printed circuit board when the soldering pin 66 is fitted in the recess 16.

### LIST OF REFERENCES

2 soldering contact
4 contact region
6 SMD soldering surface
8 SMD soldering surface
10 SMD soldering surface
12 SMD soldering surface
14 recess
16 recess
18 recess
20 soldering contact
22 soldering pin
24 surface
26 surface
28 printed circuit board
30 plug connector contact
32 plastic housing
34 web
36 web
38 contact lug
40 contact lug
42 soldering contact
44 soldering pin
46 soldering contact
48 soldering surface
50 soldering pin
52 soldering contact
54 soldering pin
56 soldering pin
58 soldering contact
60 soldering pin
62 soldering pin
64 soldering contact
66 soldering pin
R insertion direction
L longitudinal axis
P face plane

What is claimed is:

1-8. (canceled)

9. A soldering contact, comprising:
a contact region for contacting a plug connector contact;
at least one SMD soldering surface, which is configured for soldering to a printed circuit board and for materially bonded connection to a soldering pin; and
at least one recess, which is configured to receive a soldering pin.

10. The soldering contact as claimed in claim 9, wherein at least one soldering pin is provided, which is connected in a materially bonded manner to the SMD soldering surface.

11. The soldering contact as claimed in claim 9, wherein at least one soldering pin is provided, which is received, at least portionally, in the recess, and is connected in a materially bonded manner to a surface that delimits the recess and/or adjoins the recess

12. The soldering contact as claimed in claim 9, wherein:
two or more recesses are provided for receiving soldering pins; and/or
two or more SMD soldering surfaces are provided, which are configured for soldering to a printed circuit board and for materially bonded connection to a soldering pin.

13. The soldering contact as claimed in claim 10, wherein:
a longitudinal extent of the soldering pin is oriented transversely in relation to, or along, an insertion direction of the plug connector contact; and/or
the contact region has at least two projecting webs, and wherein a longitudinal extent of the soldering pin is oriented transversely in relation to, or along, a longitudinal extent of the webs.

14. The soldering contact as claimed in claim 9, wherein:
the recess and/or the SMD soldering surface are/is oriented transversely to, or along, an insertion direction of the plug connector contact; and/or
the contact region has at least two projecting webs, and wherein the recess and/or the SMD soldering surface are/is oriented transversely to, or along, a longitudinal extent of the webs.

15. A contact module for a printed circuit board, comprising:
a plastic housing;
at least one receiving opening for insertion of a plug connector; and
at least one soldering contact that is assigned to the receiving opening and accommodated in the plastic housing, wherein the soldering contact is formed as claimed in claim 9.

16. A method for producing a contact module for a printed circuit board, comprising the following steps:
providing a soldering contact or a plurality of soldering contacts as claimed in claim 9;
inserting the soldering contact or the soldering contacts into a plastic housing, wherein, optionally, materially bonded connecting of at least one soldering pin to the SMD soldering surface is effected; and/or
materially bonded connecting of at least one soldering pin to a surface that delimits the recess and/or that adjoins the recess is effected, wherein the soldering pin is received, at least portionally, in the recess.
